(19) United States
(12) Patent Application Publication
(10) Pub. No.: US 2011/0249954 A1
(43) Pub. Date: Oct. 13, 2011

(54) CAPTURING PRESENTATIONS IN ONLINE CONFERENCES

(75) Inventors: Brian Meek, Redmond, WA (US); Felix W. Wong, Bellevue, WA (US); Jayendran Srinivasan, Sammamish, WA (US); Shi Lu, Kirkland, WA (US); Mukul Gupta, Redmond, WA (US); Zheng Ni, Beijing (CN)

(73) Assignee: Microsoft Corporation, Redmond, WA (US)

(21) Appl. No.: 12/757,464

(22) Filed: Apr. 9, 2010

(51) Int. Cl. H04N 5/91

(52) U.S. Cl. 386/239; 386/E05.003; 386/291

(57) ABSTRACT

Presentations during an online conference are captured for subsequent playback. An instance of a presentation viewer is deployed to capture the presentation. Annotations and timing data are captured separately. The presentation with the annotations is recorded through a video encoding codec in a desired format, while timing and similar data is stored as metadata. Multiple presentations may be recorded separately to conserve resources. The recordation and the metadata can be subsequently played back to a requesting user.

### BACKGROUND

Modern communication systems that can provide a large number of capabilities including integration of various communication modalities with different services enable a wider array of communication between people. Online conferences facilitated by multimodal enterprise communication services are commonly used enabling people far away from each other to share ideas and collaborate through audio, video, and data exchange applications.

Online conferences typically include an audio component, sometimes a video component, and a presentation component. A primary participant may employ a presentation application during a multimodal online conference share textual, graphical, and other content. Presentation applications enable users to present documents containing text, graphics, and other data such as audio, video, animations, etc. in form of slides. During a presentation, a presenter may make changes in the document (i.e. annotate), present the data in a particular order, change direction of presentation, and perform comparable actions.

While audio and/or video components of online conferences may be recorded for subsequent viewing, multimodal conferences with presentations, particularly those with annotated presentations, present a challenge. If an online conference with a presentation is recorded in a temporally linear manner, some aspects of the presentation associated with timing of the presentation of individual elements, annotations, and the like, may not be captured in a desirable manner or the capturing process may consume large amounts of system resources.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to capturing presentations during an online conference for subsequent playback. According to some embodiments, an instance of a presentation viewer may be deployed to capture the presentation. Annotations and timing data may be captured separately. The presentation with the annotations may be recorded through a video encoding codec in a desired format, while timing and similar data is stored as metadata. The recordation and the metadata may be subsequently played back to a requesting user.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an online conference system, where embodiments may be implemented for capturing presentations;

FIG. 2 is a diagram illustrating components and interactions in capturing online conference presentations;

FIG. 3 is a diagram of major components in capturing online conference presentations and playing them back according to embodiments;

FIG. 4 is a detailed diagram of a process of capturing online conference presentations and associated components;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of capturing online conference presentations according to embodiments.

### DETAILED DESCRIPTION

As briefly described above, presentations that are part of an online conference may be captured through an instance of a presentation viewer, a video encoding codec and capture of timing data as metadata such that the presentation can be played back subsequently true to its original form. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing multimodal conferencing systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below. Also, the term “online conference” as used in conjunction with capture of presentations is intended to illustrate the distinction between a conventional execution of a presentation application on one or more devices as a distinct application and embodiments, where a presentation that is provided as part of an audio, audio/video, or multimodal conference over a networked system is captured for subsequent playback.

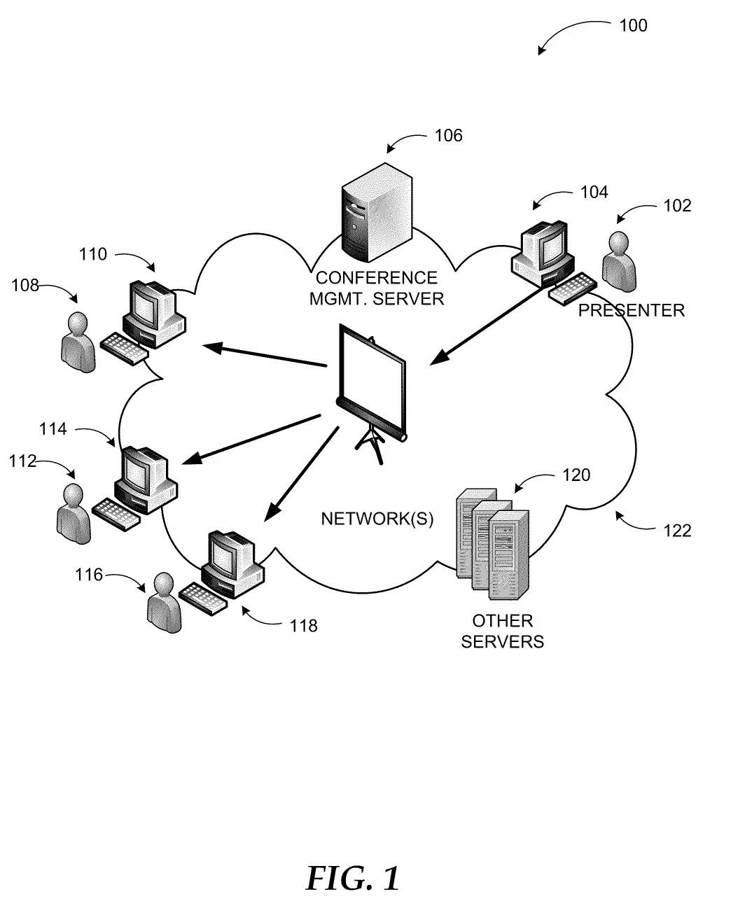

FIG. 1 is a conceptual diagram illustrating an online conference system, where embodiments may be implemented for capturing presentations. A conference system according to embodiments may be implemented as part of a unified communication system. A unified communication system is an example of modern communication systems with a wide range of capabilities and services that can be provided to subscribers. A unified communication system is a real-time communications system facilitating instant messaging, presence, audio-video conferencing, web conferencing, and similar functionalities.

In a unified communication (“UC”) system, users may communicate via a variety of end devices, which are client devices of the UC system. Each client device may be capable of executing one or more communication applications for voice communication, video communication, instant messaging, application sharing, data sharing, and the like. In addition to their advanced functionality, the end devices may also facilitate traditional phone calls through external connections. End devices may include any type of smart phone, cellular phone, any computing device executing a communication application, a smart automobile console, and advanced phone devices with additional functionality.

In addition to facilitating participation in an online conference, the end devices may handle additional communication modes such as instant messaging, video communication, etc. While any protocol may be employed in a UC system, Session Initiation Protocol (SIP) is a commonly used method to facilitate communication. SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

SIP clients may use Transport Control Protocol (“TCP”) to connect to SIP servers and other SIP endpoints. SIP is primarily used in setting up and tearing down voice or video calls. However, it can be used in any application where session initiation is a requirement. These include event subscription and notification, terminal mobility, and so on. Voice and/or video communications are typically done over separate session protocols, typically Real Time Protocol (“RTP”).

In the example online conference system of diagram 100, conference management server 106 may facilitate an online conference that includes a presentation 124 as part of the conference's modalities. Presentation 124 may be directed by presenter 102, who may interact with the system through a communication/collaboration application executed on client device 104. Presenter 102 may determine a timing of slides, appearance/disappearance of individual elements on the slides, animations, activation of objects embedded into the slides (e.g. audio files, video files), and make annotations while the presentation is displayed. Annotations are a means to add more content to an on-going presentation. They can be in the form of text, diagrams, or even a pointer (e.g. a laser-pointer's positions on the slides during the presentation). Presenter 102 may also reverse an order of slides and/or presentation of individual elements on the slides.

Participants 108, 112, and 116 may view the presentation through communication/collaboration applications executed on client devices 110, 114, and 118. While in typical implementations, participants 108, 112, and 116 may have a passive role, a system according to some embodiments may accommodate multi-directional data sharing, where participants may perform at least some of the actions assumed by the presenter (e.g. provide annotations). Communication/collaboration applications for the presenter and the participants may also be a centralized or distributed service executed by conference management server 106 or by the other servers 120. Other servers 120 may assist conference management server 106 manage the online conference system over network(s) 122 and/or perform other tasks such as those discussed above in conjunction with an enhanced communication system.

In a system according to embodiments, the presentation may be captured by initiating an instance of a presentation viewer, capturing screenshots of the presentation as it is displayed, annotations made on the presentation slides, and presentation events such as timing of appearances of the individual elements, etc. The annotations and captured screenshots of the presentation may be combined and encoded into a video file, while the presentation events are recorded as metadata. Presentation events such as slide changes, individual slide element appearance order/timing, etc. are not captured directly in the recording, but are used as part of the metadata to feed to the ‘recording system’ in order to control a hidden viewer module as described in more detail below. The video file and the metadata may then be used to playback the presentation true to its original form in the online conference.

The capturing of the presentation may be performed by any of the communication/collaboration applications on client devices, by a presentation capture module associated with the communication/collaboration applications, or by the conference management server.

While the example system in FIG. 1 has been described with specific components such as conference management server and similar devices, embodiments are not limited to these components or system configurations and can be implemented with other system configuration employing fewer or additional components. Functionality of systems capturing online conference presentations may also be distributed among the components of the systems differently depending on component capabilities and system configurations. Furthermore, embodiments are not limited to unified communication systems. The approaches discussed here may be applied to any data exchange in a networked communication environment using the principles described herein.

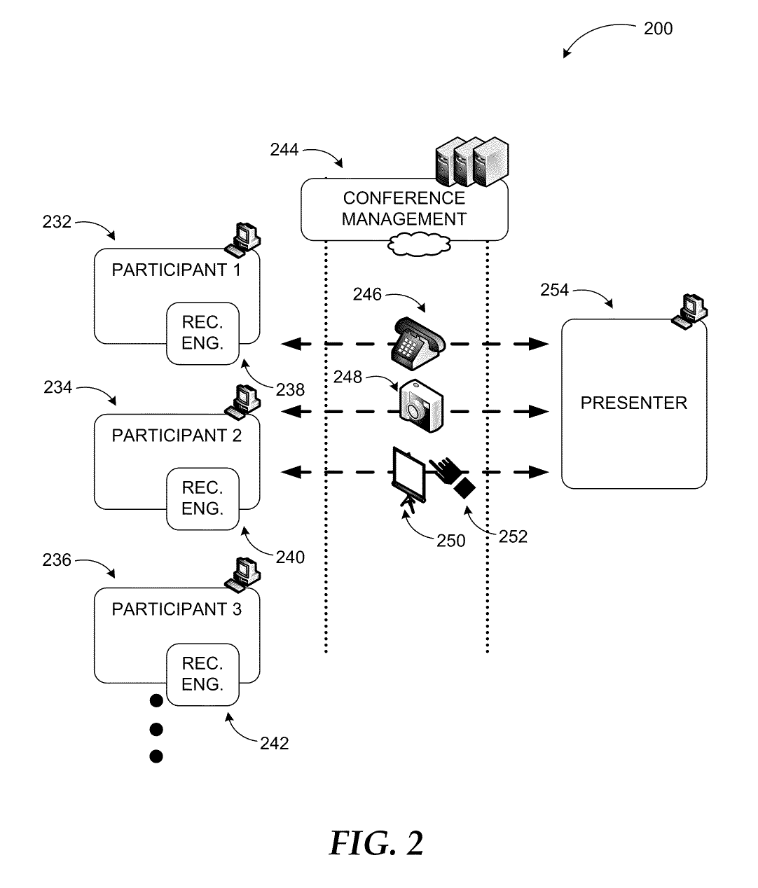

FIG. 2 is a diagram illustrating components and interactions in capturing online conference presentations. The online conference system shown in diagram 200 is one example implementation of embodiments.

Presenter 254 and participants 232, 234, 236 are in a multimodal online conference managed by conference management service 244. Audio (246) and video (248) communications are enabled between the conference participants. In addition, presentation 250 is provided by presenter 254. Presenter 254 also makes annotations 252 on presentation 250 during the conference.

According to one embodiment, the communication application for each of the participants 232, 234, and 236 may include a presentation capture module 238, 240, and 242, respectively. Each of the participants may view the presentation employing different screen resolutions, different viewport sizes. Furthermore, the participants may be enabled to view the presentation independently from the presenter's flow (i.e. they may be viewing previous slides while the presenter is on a particular slide). Thus, the viewing properties for each participant may be different. The presentation capture modules of each participant may be configured to capture the presentation true to its original form (the way the presenter presents).

According to another embodiment, the presentation may be captured at each presenter's communication application as the participant sees allowing customization for each participant. According to further embodiments, presenter 254 may provide multiple presentations and switch between those during the conference. Each presentation capture module may be configured to capture the presentations as distinct presentations (distinct video files and metadata) or as a single presentation (single video file and metadata). Alternatively, only the active presentation may be captured too.

In order to conserve system resources, separate presentation viewers may be dynamically created and destroyed according to the presentation content (in case of multiple presentations). A timer-driven frame-sampling scheme may be employed to drive the video stream generation such that an optimum balance between recorded video quality and system resource consumption can be achieved.

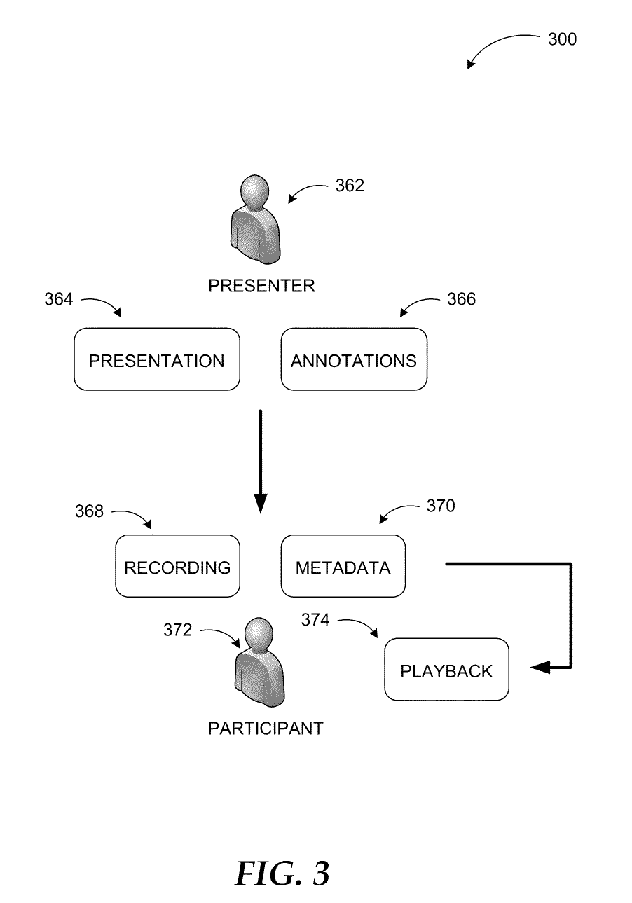

FIG. 3 is a diagram of major components in capturing online conference presentations and playing them back according to embodiments. As shown in diagram 300, presenter 362 provides presentation 364 and annotations 366. Presentation 364 implicitly includes events such as timing of slide changes, activation of individual elements, and comparable ones.

In a system according to embodiments, a hidden presentation viewer is created which may navigate to the same slide and play the same annotations as the main viewer. A screen capturing codec may be used to take snapshots of this hidden viewer, combine the annotations from the supplied metadata on top of these snapshots and then encode the snapshots onto a video file (recording 368) of desired format such as Windows Media Video (WMV) of Microsoft corp. of Redmond, Wash. The video file may be played back (374) to participant 372 later using the timing information that is also recorded as separate metadata 370. Timing information may include timing of slide changes, individual slide element appearance timing, animation timing, annotation appearance timing, and similar information. The lifetime of the hidden viewer and the capturing process may be managed efficiently in order to achieve the optimum system resource consumption while maintaining desired visual quality of the output file.

Moreover, a system according to embodiments may employ different instances of the hidden viewer. The different instances of the hidden viewer may be used to capture different dimensions of the presentation. For example, a public version of the presentation may be the one being presented to all participants, while a private version may represent how individual viewers view the presentation, where the latter may be asynchronous with the public version. Furthermore, the hidden presentation module may receive feedback associated with the events and modify the view accordingly (e.g. slide flip), so that the recorder can subsequently capture the modified version as a video stream.

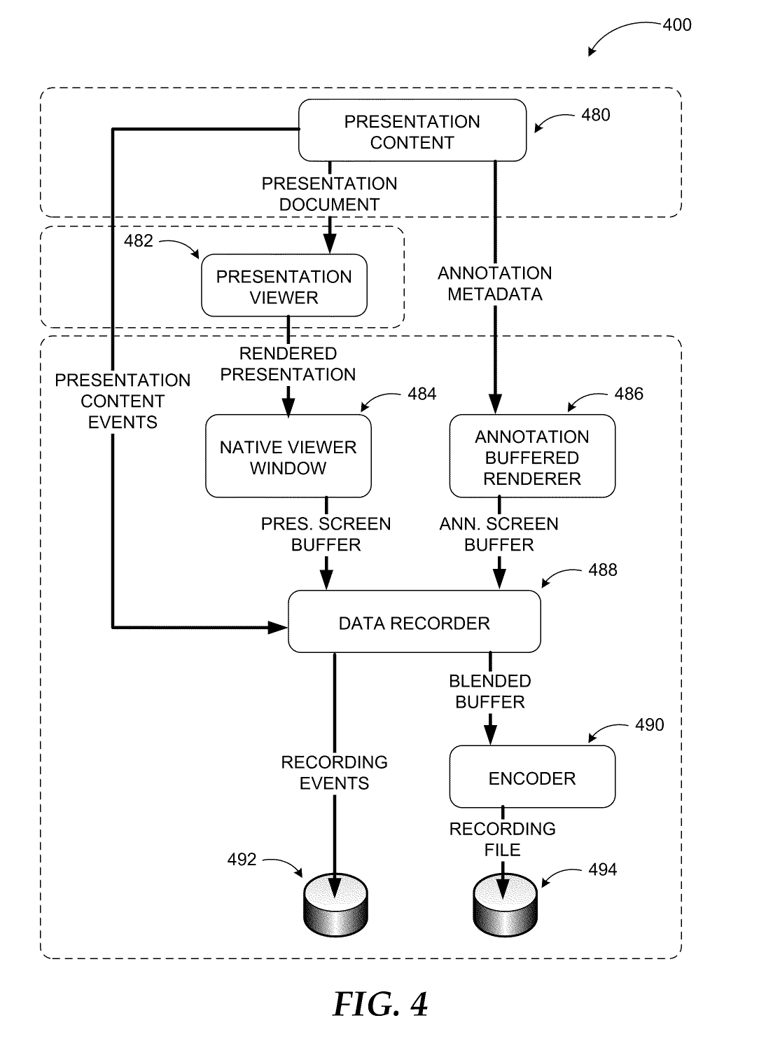

FIG. 4 is a detailed diagram of a process of capturing online conference presentations and associated components. When presentation content 480 is being recorded, a hidden instance of a presentation viewer 482 other than the presentation viewer instance hosted by the user interface, which renders the presentation, is created with predefined dimensions. Presentation content 480 is also hosted in hidden presentation viewer 482 and navigation is performed synchronously with the presentation viewer of the user interface. Screen updates of rendered presentation from the native viewer window 484 are buffered and provided to data recorder 488. Annotation metadata is also captured from the presentation content 480 and provided to data recorder 488 through annotation buffered renderer 486. Thus, user annotation changes are captured and recorded in the video of the presentation. According to some embodiments, the dimensions of the native viewer window 484 may be fixed, so that the video resolution of the recorded video is coherent with the presentation.

Data recorder 488 also receives presentation content events as discussed above and records those events to metadata storage 492. The blended buffer of presentation content and annotations is encoded into a video file of desired format by encoder 490 and then stored in recording storage 494.

In a system according to embodiments, performance of the presentation recording may be optimized by generating recording video frames at a constant rate. In this manner, an upper bound of the recording processor consumption may be established when the presentation screen contents are changing frequently (e.g. when there are animations that change very frequently). Furthermore, when the presentation screen does not have any changes, a previous frame may be duplicated in the video file, so that the video is not interrupted and resource consumption is reduced. In addition, hidden presentation viewer windows may be dynamically created and destroyed according to presentation state changes. In this manner, resource consumption due to hosting the hidden viewer windows may be minimized.

While embodiments are described with reference to “presentations”, this term should not be construed as being limited to a conventional presentation application, where successive slides containing textual and graphical data are presented. Presentation, as used herein, refers to a broader understanding of data sharing applications where content may be shared between participants of an online conference system. For example, a whiteboard sharing applications, where the content is created by the participants may also be recorded using the principles described herein.

The example systems in FIGS. 1, 2, 3, and 4 have been described with specific components such as conference management servers, client devices, video encoding codecs, and the like, embodiments are not limited to systems according to these example configurations. A multimodal online conference system employing presentation capture according to embodiments may be implemented in configurations employing fewer or additional components and performing other tasks.

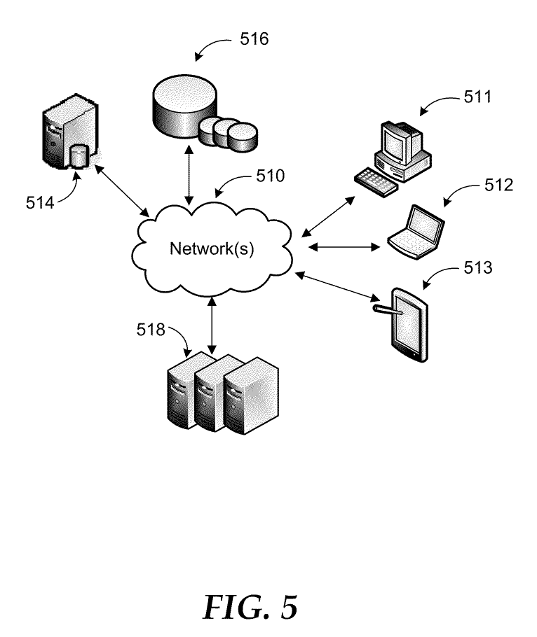

FIG. 5 is an example networked environment, where embodiments may be implemented. A platform providing presentation capturing services in online conferencing systems may be implemented via software executed over one or more servers 518 such as a hosted service. The platform may communicate with client applications on individual computing devices such as a server 513 or a laptop computer 512 and desktop computer 511 (‘client devices’) through network(s) 510.

As discussed above, a presentation capture module in association with a communication application or service may be used to record presentations along with timing and similar aspect based metadata for subsequent playback. A communication service or application executed on servers 518 or single server 514 may receive input from users through client devices 511, 512 or 513, retrieve and store data from/to data store(s) 516, and provide recordings of the captured presentations to user(s).

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement an online conferencing system with presentation capturing capability. Furthermore, the networked environments discussed in FIG. 5 are for illustration purposes only. Embodiments are not limited to the example applications, modules, or processes.

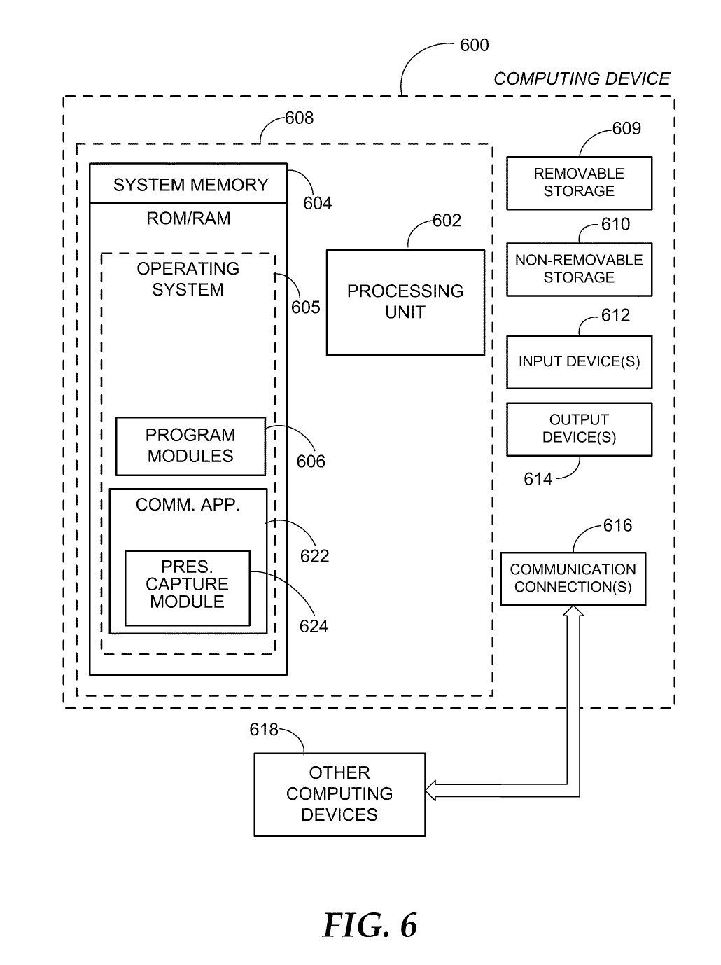

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a server or client device managing a communication application or service and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, communication application 622, and presentation capture module 624.

Communication application 622 may be any application that facilitates communication between client applications and servers relevant to an enhanced communication system and enables users to participate in online conferences. Presentation capture module 624 may record presentations employing an instance of a presentation viewer, a video encoding codec, and metadata buffers as discussed previously. The presentation capture module 624 and communication application 622 may be separate applications or integral modules of a hosted service that provides enhanced communication services to client applications/devices. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, other directory or policy servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

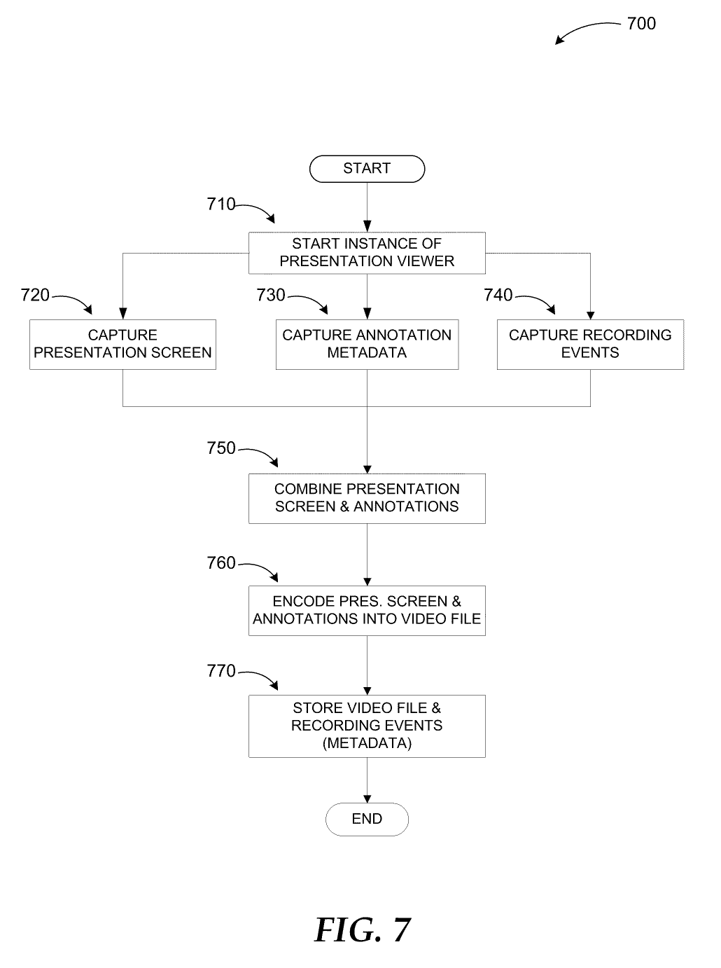

FIG. 7 illustrates a logic flow diagram for process 700 of capturing presentations in an online conference for later payback according to embodiments. Process 700 may be implemented as part of an enhanced communication application capable of facilitating online conferences client-side.

Process 700 begins with operation 710, where an instance of a presentation viewer other than one actually rendering the presentation for a participant is created. Three separate operations follow operation 710. At operation 720, presentation screens are captured from the hidden viewer instance. At operation 730 annotation metadata is captured in association with the rendered presentation screen. At operation 740, recording events associated with the presentation are captured. The recording events may include a timing of slide changes, a direction of slide changes, a timing of element activations in individual slides, and/or a timing of animations in individual slides.

The captured presentation screens are combined with respective annotations at operation 750 and encoded into a video file of desired format at operation 760. The video file and the recording events (as metadata) may be stored at operation 770 for subsequent playback true to the original form of the presentation.

The operations included in process 700 are for illustration purposes. Capturing online conference presentations for subsequent playback may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for capturing a presentation during an online conference, the method comprising:
initiating a hidden instance of a presentation viewer;
capturing presentation content from the hidden presentation viewer;
capturing annotations from the presentation;
combining the captured presentation content and corresponding annotations;
encoding the combined presentation and annotations into a video file; and
storing the video file for subsequent playback of the presentation true to its original form.

2. The method of claim 1, further comprising:
capturing presentation events from the presentation;
recording the presentation events as metadata; and
combining the metadata with the video file.

3. The method of claim 2, wherein the presentation events include at least one from a set of: a timing of slide changes, a direction of slide changes, a timing of element activations in individual slides, and a timing of animations in individual slides.

4. The method of claim 1, further comprising:
employing a screen capturing codec to encode the presentation content and the corresponding annotations into the video file.

5. The method of claim 1, further comprising:
employing a timer-driven frame-sampling scheme to encode the video file such that a recorded video quality and a system resource consumption are balanced.

6. The method of claim 5, wherein the frame-sampling scheme includes at one of: generating recording video frames at a predefined rate and duplicating a frame in the video file if an associated presentation screen is unchanged.

7. The method of claim 6, wherein the predefined rate is determined based on a change rate of presentation screen contents.

8. The method of claim 1, further comprising:
creating and destroying the hidden presentation viewer instance based on the presentation content.

9. The method of claim 1, further comprising:
initiating a plurality of hidden instances of the presentation viewer to capture different dimensions of the presentation; and
encoding a different video file for each instance of the hidden presentation viewer.

10. The method of claim 1, wherein the presentation is captured at a client application associated with one of a plurality of participants of the online conference.

11. The method of claim 10, wherein a dimension and a resolution of the captured presentation are determined based on parameters of a presenting participant of the online conference.

12. A computing device for capturing presentations during an online conference, the system comprising:
a memory;
a processor coupled to the memory, the processor performing actions including:
initiating a hidden instance of a presentation viewer for an active presentation;
capturing presentation content from the hidden presentation viewer;
capturing annotations from the presentation;
combining the captured presentation content and corresponding annotations;
encoding the combined presentation and annotations into a video file employing a screen capturing codec;
capturing presentation event timing from the presentation;
recording the event timing as metadata; and
storing the video file and the metadata for subsequent playback of the presentation true to its original form.

13. The computing device of claim 12, wherein the presentation is captured based on display parameters of one of: a presenter and one of a plurality of participants of the online conference.

14. The computing device of claim 12, wherein a plurality of presentations is displayed during the online conference, and the processor is further configured to:
creating and destroying distinct hidden presentation viewers for each of the presentations dynamically such that system resource consumption is optimized; and
receiving feedback associated with events relating to viewing of the presentation and modifying the metadata based on the received feedback.

15. The computing device of claim 12, wherein the presentation is captured by one of: a communication/collaboration application displaying the presentation to a participant, a presentation module integrated to the communication/collaboration application, and a distributed online conference service.

16. The computing device of claim 12, wherein the event timing includes timing associated with at least one from a set of: appearance/disappearance of elements on presentation slides, activation of objects embedded into the presentation slides, and appearance of annotations on the presentation slides.

17. A computer-readable storage medium with instructions stored thereon for capturing a presentation during an online conference, the instructions comprising:
at a client device facilitating the online conference for a participant, initiating a hidden instance of a presentation viewer synchronously rendering the presentation;
capturing presentation content from the hidden presentation viewer;
capturing annotations from the presentation;
encoding the captured presentation and annotations into a video file employing a timer-driven frame-sampling scheme at a screen capturing codec;
recording presentation timing data from the presentation;
recording the timing data as metadata; and
storing the video file and the corresponding metadata for subsequent playback of the presentation.

18. The computer-readable medium of claim 17, further comprising:
capturing a whiteboard sharing application rendering and associated annotations; and
encoding the captured whiteboard rendering and annotations into another video file.

19. The computer-readable medium of claim 18, wherein dimensions of the hidden instance of the presentation viewer are maintained at a predefined value to preserve a coherence of a video resolution of the recorded video with the presentation.

20. The computer-readable medium of claim 17, wherein the presentation is rendered by a communication/collaboration application synchronously facilitating at least one from a set of: a voice communication session, a video communication session, an instant message exchange, an email exchange, an application sharing session, and a data sharing session.
